(19) United States
(12) Patent Application Publication
(10) Pub. No.: US 2007/0140244 A1
(43) Pub. Date: Jun. 21, 2007

(54) Optimal algorithm for large message broadcast

(75) Inventor: Bin Jia, Poughkeepsie, NY (US)

Correspondence Address: Lily Neff;IBM Corporation - MS P386, 2455 South Road, Poughkeepsie, NY, 12601, US

(73) Assignee: International Business Machines Corporation, Armonk, NY (US)

(21) Appl. No.: 11/314,418

(22) Filed: Dec. 21, 2005

(51) Int. Cl. H04L 12/56

(52) U.S. Cl. 370/390

(57) ABSTRACT

A method and associated program storage device readable by a machine embodying the method for message broadcasting in a parallel computing environment is enclosed. The method comprises the steps of first performing a set up process phase by first determining how the message is sliced to be broadcasted and then establishing parent-child relationship among processes such that parent will be responsible to pass any message received to said child. Thereafter, ensuring that all non-root processes get one slice of the message and pass it along to their designated children and performing a pipelining process phase consisting of multiple sub steps during which broadcasted cesses and having each process exchange a slice of message with its partner based on preselected criteria.

### BACKGROUND OF THE INVENTION

1. Field of the Invention

The present invention relates to message broadcasting in large computing system and in particular to an algorithm that achieves optimal results in message broadcasting in a large computing system.

2. Description of Background

Large computing environments often include a network of computers that are in processing communication with one another. The networked computers can be loosely coupled forming a computer cluster. In such arrangements the loosely coupled computers work together closely so that in many respects they can be viewed as one computer. In addition, many such large environments provide parallel processing capabilities. The term parallel processor is sometimes used for a computer with more than one processor, available for parallel processing. Systems with thousands of such processors are known as massively parallel.

There are many different kinds of parallel computers or parallel processors. They are distinguished by the kind of interconnection between processors, known as processing elements (PEs) and between processors and memories. Parallel processor machines are also divided into symmetric and asymmetric multiprocessors, depending on whether all the processors are capable of running all the operating system code and, say, accessing I/O devices or if some processors are more or less privileged.

Computer clusters and parallel processing is used both to achieve greater speed better performance. However, the speed and performance of the system greatly depends on how data is processed and transmitted during computing operations. In this regard, message broadcasting has become of utmost importance in the design of large computing systems. Broadcasting in a computer network refers to transmiting a packet that will be received (conceptionally) by every device on the network. The packets are usually small and of fixed size. At parallel application level, broadcasting refers to transmiting a message from one process to other processes running on the parallel computers. The messages can be large and consist of multiple packets.

A particular challenge in the design of large computing environments, and particulalry in parallel computing, is to use algorithms that are often essentially sequential in nature in a cooperative fashion to achieve the desired parallel result. Most algorithms must be completely redesigned to be effective in parallel environments. This is particularly true in circumstances where multiple copies of the same program may interfere with one another.

As mentioned earlier, broadcasting is widely used by parallel applications in such environments and therefore the prior art has struggled with providing algorithms that can efficiently boradcast a large message among the group of processes. Unfortunately, the prior art algorithms currently being used either do not provide an optimal communication schedule or the scheduling is not practical for implementation of large message broadcasts on different kind of processes such as power of two and non power of two processes. For example the implementation of Scatter-Allgather algorithm is straightforward, but it does not fully and optimally uses the available bandwidth. By contrast, Edge-disjoint Spanning Binnomial Tree algorithm performs better but has a very complex structure and only works on power of two processes. Another algorithm that works both owth power of two and non power of two processes is Partition_exchange algorithm but while the scheduling is simple for the communication content part, the communication partner determination is highly complicated. Consequently, a novel algorithm for broadcasting large messages is needed that can overcome the above mentioned shortcomings of the prior art.

### SUMMARY OF THE INVENTION

The shortcomings of the prior art are overcome and additional advantages are provided through the method and associated program storage device readable by a machine embodying the method for message broadcasting in a parallel computing environment is enclosed. The method comprises the steps of first performing a set up process phase by first determining how the message is sliced to be broadcasted and then establishing parent-child relationship among processes such that parent will be responsible to pass any message received to said child. Thereafter, ensuring that all non-root processes get one slice of the message and pass it along to their designated children and performing a pipelining process phase consisting of multiple sub-steps during which broadcasted message slices are further pipelined by establishing partner relationship among processes and having each process exchange a slice of message with its partner based on preselected criteria.

Additional features and advantages are realized through the techniques of the present invention. Other embodiments and aspects of the invention are described in detail herein and are considered a part of the claimed invention. For a better understanding of the invention with advantages and features, refer to the description and to the drawings

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic illustration of a computing environment used for broadcasting as per one embodiment of the present invention;

FIG. 2 is a flow chart illustration of set up process as per one embodiment of the present invention; and

FIG. 3 is a flow chart illustration of a pipelining process as per one embodiment of the present invention.

### DESCRIPTION OF THE INVENTION

The present invention provides for a novel algorithm for broadcasting large messages. The algorithm provides an optimal communication schedule and the scheduling is practical for implementing large message broadcast in communication libraries. Specially, the algorithm performs optimal broadcasting of large messages on both power of two and non power of two processes.

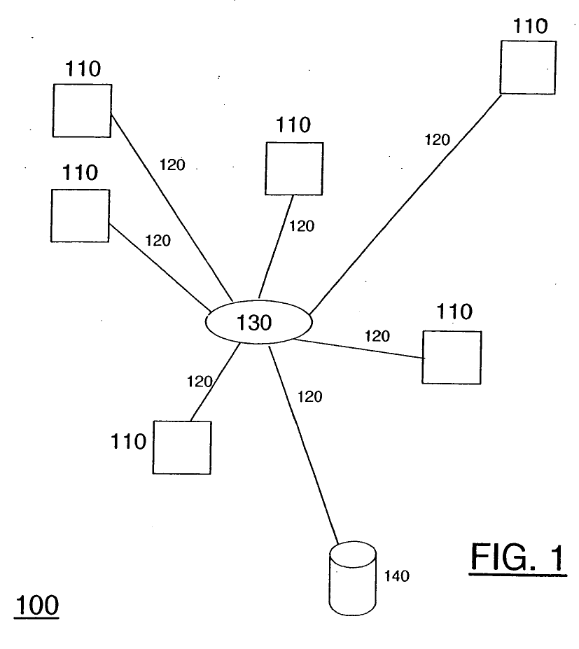

FIG. 1 provides a schematic illustration of a computing environment 100 comprising of a plurality of nodes 110 that are networked together via a communication network 120. While a variety of different embodiments can be selected, for ease of understanding, in the following discussion, it is assumed that the computing environment 100 is a parallel processor. The communication network 120 can comprise a variety of components known to those skilled in the art including but not limited to local area networks (LANs) 130. One or more storage devices, generally indicated by 140 that can include main storage and cache storage is also provided as shown.

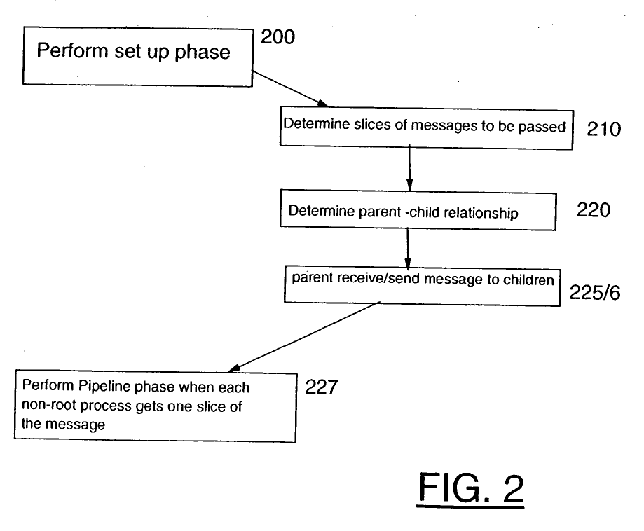

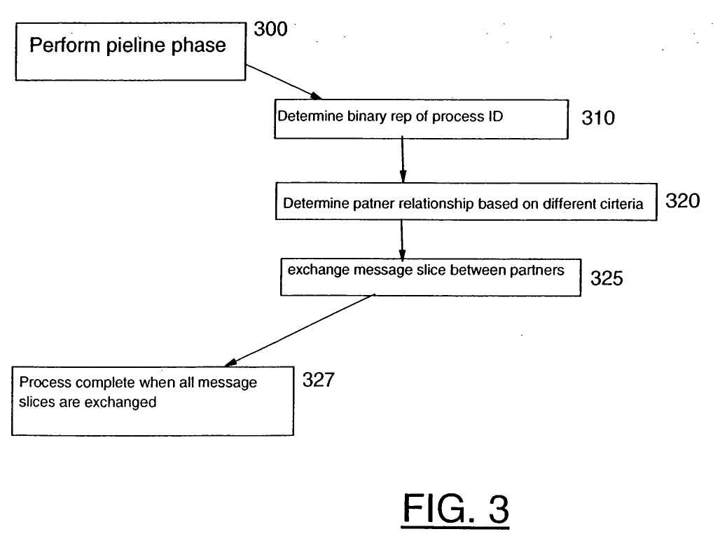

FIGS. 2 and 3 each provide flow chart illustrations of the process as suggested by the present invention. Before examining these flowcharts, however, it should be noted that for ease of understanding in the following discussions broadcast is used in conjunction with parallel applications. The standard used in these broadcasts is the message passing interface (hereinafter, MPI) standard. The MPI standard defines a collective communication operation called MPI_BCAST, which will be used for discussion here, with the understanding that other similar standards can also be used in alternate embodiments.

In MPI_BCAST, the process that has the message initially is called the root. The root sends the message to a group of processes. For the convenience of discussion, we assume process 0 is the root. At the end of MPI_BCAST, every process has a copy of the message. We discuss single large message broadcast algorithms only in the present instance to keep the understanding of the discussion relatively simple with the understanding that the same idea can be applied to broadcasting a series of messages from the same source.

To efficiently broadcast a large message among the group of processes and nodes 110 (of FIG. 1), the most widely adopted approach is for the root to split up the large message into small slices and pipeline those slices into the system. Different slices may take different paths to reach other processes. The purpose for the pipelining is to fully utilize available bandwidth in the system. Several large message broadcast algorithms in the prior art are developed using this approach.

The differences among those algorithms are their pipeline schedules and scheduling methods, i.e. how schedules are constructed. According to the pipeline schedule, a process can determine at each communication step: 1) its communication partners, i.e. the source process of the incoming slice and the target process of the outgoing slice, and 2) the communication content, i.e. which slice comes in and which slice goes out. An optimal schedule is the key to performance while low scheduling complexity and overhead make an algorithm practical to be implemented and incorporated in communication libraries such as MPI.

It may be useful to carefully examine the workings of Scatter-Allgather, Edge-disjoint Spanning Binomial Tree and Partition-Exchange algorithms previously discussed briefly to achieve a better understanding of the workings of the present invention.

In a Scatter-Allgather algorithm often used for large message MPI_BCAST, the root split the message up into P slices, where P is the number of process in the group, including the root. It then scatters the entire message out to all P participating processes by every process calling MPI_SCATTER. As a result of the scatter, every process gets at least one slice of the message. Then the scattered slices are collected back at each process by calling MPI_ALLGATHER. In the MPI_ALLGATHER, each of the P processes acts as if it has only one distinctive slice after the scatter and it contributes this distinctive slice to the group.

This algorithm is easy to implement. The schedulings in both the scatter phase and the allgather phase are simple and straightforward. However, the performance of this algorithm is not optimal because available bandwidth is not fully utilized in the scatter phase and there are redundant data transfers in the allgather phase. The communication partner relationship in each step is shown in the following table for an example of broadcasting on 4 processes using this algorithm. The communication content can be seen in the following table which shows the slices available at each process. Process 0 is the root and there are 4 processes in the group. Table 1 and 2 below, show an example of this:

TABLE 1

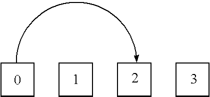

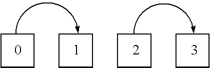

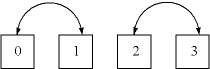

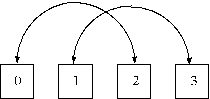

TABLE 2

Process

| | 0 | 1 | 2 | 3 |
|---|---|---|---|---|
| Initial state | 0123 | | | |
| Scatter step 0 | 0123 | | 23 | |
| Scatter step 1 | 0123 | 1 | 23 | 3 |
| Allgather step 0 | 0123 | 01 | 23 | 23 |
| Allgather step 1 | 0123 | 0123 | 0123 | 0123 |

The n Edge-disjoint Spanning Binomial Trees (nESBT) algorithm was developed for hypercubes systems. Its idea is to construct nESBT graph by merging n spanning binomial trees (SBT). The SBTs are extracted from the n-cube and then rotated certain number of times. The root sends slices to the SBTs in a round robin manner and each slice is broadcasted along one SBT. This algorithm performs better than the Scatter-Allgather algorithm but the implementation could be highly complicated. First, the nESBT graph construction is very complex. Secondly, the communication partner part of scheduling is simple but to determine communication content during each step, nESBT graph traverse is required, which results in high complexity and overhead. This algorithm can be ported to other platforms but only works on power of two processes.

Another algorithm deals both power of two and non power of two processes. It's called Partition-Exchange algorithm in this application. The idea is to partition the P processes in to several subsets during each communication step. There are logP subsets for power of two processes and └logP┘+3 subsets for even number non power of two processes. For odd number non power of two processes, a dummy process is added into the group.

The dummy process does not participate in message passing and the algorithm acts as if there are P+1 processes. In each step, a process is paired up with another process from a different subset and slices are exchanged between the two. What slices a process has received previously determines which subset it belongs to and in turn decides what slice it should send and receive during the current step.

For power of two processes, the communication schedule is essentially the same as the nESBT algorithm but constructed differently. Unlike the nESBT algorithm, the communication content part of the scheduling is simple but the communication partner determination is highly complicated, especially for non power of two processes. The nESBT and the Patition-Exchange algorithms perform better theoretically than the Scatter-Allgather algorithm. However their schedulings are impractical for MPI implementations.

Referring back to FIG. 2, in the present invention a novel methodology for broadcasting large messages is provided that enables an optimal communication schedule and the scheduling is practical for implementing large message broadcast in communication libraries. Specially, the methodology and associated algorithm performs optimal for large message broadcast on both power of two and non power of two processes.

Both the communication partner and the communication content are easily determined with the new scheduling by simply checking the binary representation of the process ID. For power of two processes, the communication schedule generated by this algorithm is relatively similar to that as discussed in conjunction with the nESBT algorithm and the Partition-Exchange algorithm, but with novel, low complexity and low overhead scheduling. For non power of two processes, both the communication schedule and the scheduling are very different from prior art solution.

For broadcasting among P (P is power of two) processes, as illustrated in the flowchart illustration of FIG. 2, there are two main steps in the methodology suggested by the present application. The first phase is a setup phase as referenced by 200 and the second main phase is the pipeline phase referenced by 300. The message is divided into q slices.

In the setup phase 200, the first n=logP slices of the message are passed along a binomial tree 220 whose parent-children relationship is defined as follows:

Definition 1:

for i=(iₙ₋₁ iₙ₋₂ . . . iᵣ . . . i₀) and r satisfies:

iᵣ=1 and iₙ₋₁=iₙ₋₂= . . . =iᵣ₊₁=0 if i ≠0; or r=−1 if i=0,

the parent and children of process i are:
Child (i, s)={(iₙ₋₁ . . . i̅ᵣ̅₊̅ₛ̅₊̅₁̅ . . . iᵣ . . . i₀)|sε{0, 1, . . . , n−r−2}}.
Parent (i)=(iₙ₋₁ iₙ₋₂ . . . i̅ᵣ̅ . . . i₀)

According to the definition, process 0 has n children. As per workings of the invention, it sends out the first n slices, one to each of its children as shown at 225. Each process, except for process 0, gets one slices from its parent in the setup phase. Once received a slice, a process sends it to each of its children, one by one, as shown at 226.

Consequently for a process i, process i=(iₙ₋₁ iₙ₋₂ . . . iᵣ . . . i₀) expects from its parent slice t where t satisfies: iₜ=1 and iₜ₋₁=iₜ₋₂= . . . =i₀=0. This setup takes n steps and at the end, every non-root process gets one slice of the message (227).

The pipeline phase 300 also consists of several steps. Similar to the setup phase. During this phase the parent-child relationship is replaced by a partner-shipping of pairs as depicted by process step 320. This partnership can be achieved in a number of ways as will be discussed in detail below. Note that the communication partner and the communication content can be easily determined by checking the binary representation of the process ID as shown at 310.

Fore each process, once a partner is determined as referenced at 320, then at least one slice of the message is then exchanged with the partner as shown at 325 until the process is completed as depicted by 327.

That is to say that for example, in step k, process i exchanges one slice with a partner process. The partner is determined by flipping bit k % n of i:

Definition 2:

for i=(iₙ₋₁ iₙ₋₂ . . . iᵣ . . . i₀), Partner (i, k)=(iₙ₋₁ iₙ₋₂ . . . i̅_̅{̅k̅ %̅ n̅}̅ . . . i₀).

For example, when process 0 is the partner, the process receives slice k+n from process 0 if k<q−n, or slice q−1 otherwise.

Process 0, on the other hand, sends to its partner slice k+n or slice q−1 if k>=q−n.

When neither i nor Partner(i, k) is process 0, i sends slice k+s(i, k) to Partner(i, k) and receives slice k+t(i, k) from Partner(i, k). If k+s(i, k) or k+t(i, k)>=q, then slice q−1 is sent or received instead. s(i, k) and t(i, k) are given by:

Definition 3:

for i=(iₙ₋₁ iₙ₋₂ . . . iᵣ . . . i₀), s(i, k) satisfies i̅_̅{̅k̅ %̅ n̅}̅=i_{(k+1)%n}= . . . i_{(k+s(i, k)-1)% n}=0 and i_{(k+s(i, k))% n}=1. t(i, k) satisfies i̅_̅{̅k̅ %̅ n̅}̅=i_{(k+1)% n}= . . . i_{(k+t(i, k)-1)% n}=0 and i_{(k+t(i, k))% n}=1.

An example of the algorithm is shown in Tables 3 and 4 below:

TABLE 3

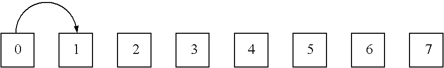

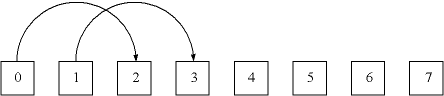

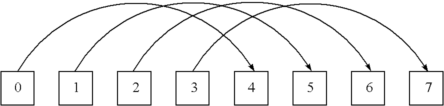

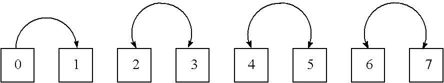

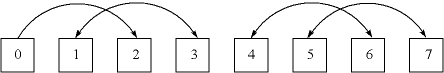

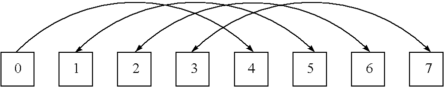

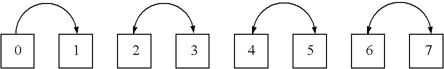

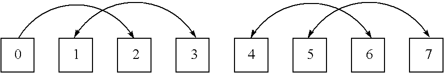

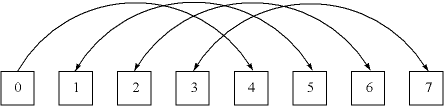

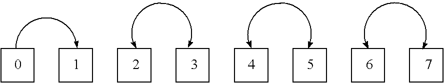

Communication Partner:
slice exchange schedule on power of two processes, P = q = 8

TABLE 4

| | 1 | 2 | 3 | 4 | 5 | 6 | 7 |
|---|---|---|---|---|---|---|---|
| Setup 0 | 0 | | | | | | |
| Setup 1 | 0 | 1 | 0 | | | | |
| Setup 2 | 0 | 1 | 0 | 2 | 0 | 1 | 0 |
| Pipeline 0 | 30 | 10 | 10 | 20 | 20 | 10 | 10 |
| Pipeline 1 | 310 | 410 | 310 | 210 | 210 | 210 | 210 |
| Pipeline 2 | 3210 | 4210 | 3210 | 5210 | 3210 | 4210 | 3210 |
| Pipeline 3 | 63210 | 43210 | 43210 | 53210 | 53210 | 43210 | 43210 |
| Pipeline 4 | 643210 | 743210 | 643210 | 543210 | 543210 | 543210 | 543210 |
| Pipeline 5 | 6543210 | 7543210 | 6543210 | 7543210 | 6543210 | 7543210 | 6543210 |
| Pipeline 6 | 76543210 | 76543210 | 76543210 | 76543210 | 76543210 | 76543210 | 76543210 |

Communication Content: slices received after each steps on power of two processes, P = q = 8

A simple approach is used to extend the algorithm to non power of two processes. The idea is to pair up the processes into power of two pairs, self-pair allowed, and then follow the algorithm as if each pair is one process. When broadcasting on P′ processes, where P <P′<2*P, we first define a simple scheme that pairs up processes i≧P with process 1 to P′−P:
Definition 4: for any process i,

$$Pair ( i ) = \{ \begin{matrix}i - P + 1 & i \geq P \\ P - 1 + i & 0 < i \leq {P}^{′} - P \\ i & otherwise\end{matrix} \\ and \\ Rep ( i ) = \{ \begin{matrix}i & i < P \\ Pari ( i ) & otherwise\end{matrix}$$

Process i participates in the setup phase if and only if i=Rep(i). The setup phase is exactly the same as in the power of two processes case. In the pipeline phase, Rep(i) is used instead of i in partner calculation. During each step of the pipeline, process i and Pair(i) cooperate to accomplish slice exchanging with their partner or partners. One of the pair sends the outgoing slice to the partner and is called the output of the pair. The other, labeled input of the pair, receives the incoming slice from the partner. Note the sources of the incoming slice and the target of the outgoing slice are different if the Partner(i, k) ≠ Pair(Partner(i, k)). The input also passes a slice it received during previous steps to the output.

More specifically, at the beginning of the pipeline, when i ≠Pair(i), process i is labeled as the output of the pair if i=Rep(i), and Pair(i) is the input. Otherwise it is the other way around. If i=Pair(i), i is both the output and the input. During step k of the pipeline, the output sends slice k+s(Rep(i), k) to the input of the partner pair {Partner(Rep(i), k), Pair(Partner(Rep(i), k))} if k<q−s(Rep(i), k). If k≧q−s(Rep(i), k), it sends slice q−1 instead. The input of the pair receives slice k+t(Rep(i), k) from the output of the partner pair if k<q−t(rep(i), k). It receives slice q−1 if otherwise. When k >0, the input also sends slice k−1 to the output. A process's role in the pair may change. If Rep(i)ₖ=1, the input and output of {i, Pair(i)} switch roles after step k. To determine which of {i, Pair(i)} is the output, we define u(i, k) and v(i, k):

Definition 5: u(i, k) is the number of 1s in binary representation of i from bit 0 to bit k. v(i, k) is the number of role switches before step k (k>0), and v(i, k) is given by:
v(i, k)=└k/n┘*u(i, n−1)+u(i, k % n).

According initial role assignment, if v(i, k) is a odd number, then process i is the input of the pair if i=Rep(i) and Pair(i) is the output. Otherwise it is the other way around. Finally, after q−1 steps of the pipeline, the input of the pair sends slice q−2 to the output and the output send slice q−1 to the input, if i≠ Pair(i). Tables 5 and 6 depict an example of the algorithm.

TABLE 5

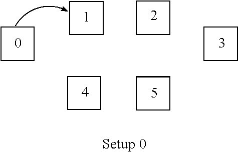

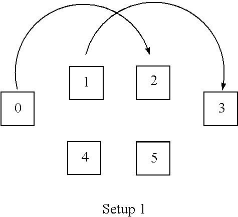

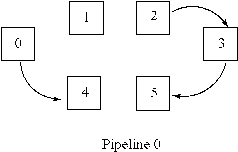

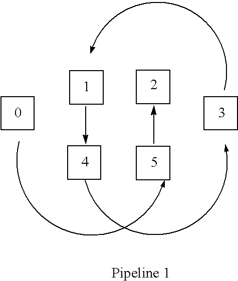

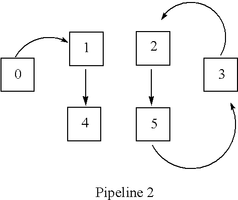

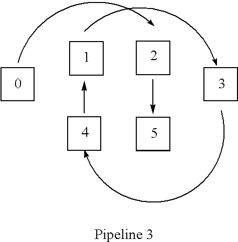

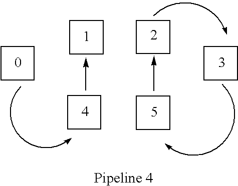

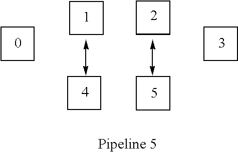

Communication Partner: slice exchange schedule on non power of
two processes, P = q = 6, 1 is paired up with 4, 2 is paired up with 5

TABLE 6

| 0 | 1 | 2 | 3 | 4 | 5 |
|---|---|---|---|---|---|
| Setup 0 | 0 | | | | |
| Setup 1 | 0 | 1 | 0 | | |
| Pipeline 0 | 0 | 1 | 10 | 2 | 0 |
| Pipeline 1 | 10 | 10 | 210 | 20 | 30 |
| Pipeline 2 | 410 | 210 | 3210 | 210 | 310 |
| Pipeline 3 | 4210 | 5210 | 43210 | 3210 | 3210 |
| Pipeline 4 | 43210 | 53210 | 543210 | 53210 | 43210 |
| Pipeline 5 | 543210 | 543210 | 543210 | 543210 | 543210 |

Communication Content: slices receive at each step with the scheduling on non power of two processes, P = q = 6, 1 is paired up with 4, 2 is paired up with 5

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of broadcasting data in a parallel computing environment, comprising:
performing a set up process phase by first determining how the message is sliced to be broadcasted;
establishing parent-child relationship among processes such that parent will be responsible to pass any message received to said child;
ensuring that all non-root processes get one slice of the message and pass it along to their designated children;
performing a pipelining process phase consisting of multiple sub steps during which broadcasted message slices are further pipelined by establishing partners based on preselected data so that message slices received earlier can be exchanged between partners.

2. The method of claim 1, wherein said message is divided into q slices.

3. The method of claim 2, wherein the first n=logP slices of the message are passed along a binomial tree. P is the number of processes participating the message broadcasting. P is power of two.

4. The method of claim 3, wherein said binomial tree establishes the parent-children by the following formula: for i=(iₙ₋₁ iₙ₋₂ . . . iᵣ . . . i₀) and r satisfies: iᵣ=1 and iₙ₋₁=iₙ₋₂= . . . =iᵣ₊₁=0 if i ≠0; or r=−1 if i=0, the parent and children of process i are:
Child (i, s)={(iₙ₋₁ . . . i̅ᵣ̅₊̅ₛ̅₊̅₁̅ . . . iᵣ . . . i₀)|Sε{0, 1, . . . , n−r−2}}.
Parent (i)=(iₙ₋₁ . . . i̅ᵣ̅ . . . i₀

5. The method of claim 1, wherein said partner relationship is established based on the following formula: for i=(iₙ₋₁ iₙ₋₂ . . . iᵣ . . . i₀), partner process of process i during sub step k of the pipeline process phase is Partner (i, k)=(iₙ₋₁ iₙ₋₂ . . . i̅_̅{̅k̅%̅n̅}̅ . . . i₀).

6. The method of claim 1, wherein said processes are paired up into power of two pairs of processes.

7. The method of claim 6, wherein self pairing is also allowed.

8. The method of claim 6, wherein when broadcasting on P′ processes, where P<P′<2*P, partners are defined by pairing up processes i≧P with process 1 to P′−P.

9. The method of claim 8, wherein the pairs are determined by the following formula: Pair(i)=i−P+1 for i greater or equal to P; P−1+ i for i greater than 0 but less or equal to P′−P; and i otherwise.

10. The method of claim 8 wherein Rep(i) is determined as i for i<P and Pair(i) otherwise.

11. The method of claim 10 wherein Rep(i) is used instead of i in partner calculation.

12. The method of claim 11, wherein during each said pipeline phase, process i and Pair(i) cooperate to accomplish slice exchanging with their partner or partners.

13. The method of claim 12, wherein one of said pair sends an outgoing slice to its partner and is called output of the pair with said other partner being the input of said pair and receiving incoming slice from its partner.

14. The method of claim 13, wherein if i=Pair(i), then i is both said output and said input.

15. The method of claim 13, wherein output sends slice k+s(Rep(i), k) to the input of its partner pair {Partner(Rep(i), k), Pair(Partner(Rep(i), k))} if k<q−s(Rep(i), k). If k≧q−s(Rep(i), k), it sends slice q−1 instead.

16. The method of claim 15, wherein input of said pair receives slice k+t(Rep(i), k) from the output of the partner pair if k<q−t(rep(i), k). It receives slice q−1 if otherwise.

17. The method of claim 16, wherein when k>0, said input also sends slice k−1 to said output.

18. The method of claim 17, wherein role of processes in said pair may be changeable.

19. The method of claim 18, wherein said change in role occurs if Rep(i)ₖ=1, said roles of said input output of {i, Pair(i)} being switched after step k.

20. A program storage device readable by a machine embodying a program instruction executable by said machine to perform method steps in a parallel transaction comprising the steps: performing a set up process phase by first determining how the message is sliced to be broadcasted;
establishing parent-child relationship among processes such that parent will be responsible to pass any message received to said child;
ensuring that all non-root processes get one slice of the message and pass it along to their designated children; and performing a pipelining process phase consisting of multiple sub steps during which broadcasted message slices are further pipelined by establishing partner relationship among processes and having each partner exchange a slice of message with its partner based on preselected criteria.
